(19) United States
(12) Patent Application Publication
(10) Pub. No.: US 2010/0116425 A1
(43) Pub. Date: May 13, 2010

(54) STACK OF ADHESIVE LABELS AND METHOD FOR APPLYING SAME TO SUBSTRATES

(75) Inventors: Patricia R. KONSTI, Oakdale, MN (US); Andrew J. Callinan, Shoreview, MN (US)

Correspondence Address: 3M INNOVATIVE PROPERTIES COMPANY, PO BOX 33427, ST. PAUL, MN, 55133-3427, US

(73) Assignee: 3M Innobative Properties Company

(21) Appl. No.: 12/617,852

(22) Filed: Nov. 13, 2009

Related U.S. Application Data
(60) Provisional application No. 61/114,270, filed on Nov. 13, 2008.

(51) Int. Cl. B65C 1/00; B29C 65/48; B32B 33/00

(52) U.S. Cl. 156/230; 428/40.1; 428/42.1

(57) ABSTRACT

A linerless stack of adhesive labels comprising a plurality of labels, each label comprising a sheet having front face and rear face and a layer of pressure sensitive adhesive on only a portion of the rear face, each label having a separable tab portion and label portion is provided. Also, a method for labeling an article comprising: providing a linerless stack of labels; providing an article; removing the uppermost label from the stack by lifting or pull on its tab portion so as to cause the adhesive on the uppermost label to separate from the front face of the underlying label; then positioning the removed label in desired position on an article; adhering the label to the article with the adhesive; and separating the tab portion of the label from the label portion of the label.

### CROSS-REFERENCE TO RELATED APPLICATION

This application claims priority to U.S. Provisional Patent Application No. 61/114,270, filed Nov. 13, 2008.

### FIELD OF INVENTION

The present invention relates to stacks of adhesive labels, in particular, stacks of adhesive labels with no intervening liner between labels, and also a method for labeling articles with such labels.

### BACKGROUND

Linerless stacks or pads of labels, i.e., adhesive-backed labels which are arranged in stacked or padded form with no release liner between adjacent labels, are known to have advantages over conventional pressure sensitive adhesive labels which are mounted on a liner. A linerless stack or pad arrangement can offer such advantages as lower costs due to material reduction, elimination of disposal concerns, and reduced bulk of a quantity of labels.

Illustrative examples of linerless labels in stack or pad configuration are disclosed in, e.g., U.S. Pat. Nos. 5,195,265 (Klingenberg) and 6,129,965 (Langan).

The need exists, however, for labels in linerless stack or pad form which provide improved performance.

### SUMMARY OF INVENTION

The present invention provides adhesive-backed labels in a linerless stacked or padded arrangement and method for labeling articles using such stacked labels.

In brief summary, a stack or pad of the invention comprises a plurality of labels, each label comprising a sheet having a front face and rear face opposite to the front face and a layer of pressure sensitive adhesive on a portion of the rear face of the sheet. Each label has a separable tab portion and label portion. Preferably the front surface of the label portion is indicia-receptive. Preferably, the tab portion is substantially free of adhesive to facilitate removal of the sheet from the stack. The labels are arranged in the stack with no removable liner between successive labels. The adhesive on the rear surface of each label in the stack, with the exception of the lowermost label in the stack, overlies and is detachably adhered to the front surface of the successive underlying sheet. The adhesive of the bottommost sheet in the stack will typically engage a protective liner. As used herein “linerless” means that within a stack adjacent labels are not separated by intervening liners; its does not refer to the potential presence of such a protective liner on the bottommost label in the stack.

Briefly summarizing, the method of the invention comprises:
providing a stack of labels as described herein;
providing an article; and
applying a separation force to the tab portion of the uppermost label in the stack, thereby causing the adhesive on the uppermost label to separate from the front face of the underlying label thereby yielding a dispensed label; and then
positioning the dispensed label in desired position on the article;
adhering the dispensed label to the article with the adhesive; and
separating the tab portion from the label portion of the dispensed label.

In accordance with the present invention, a user of the labels can achieve many handling and performance advantages including convenient use, reduced waste, and cost effective labeling.

### BRIEF DESCRIPTION OF DRAWING

The invention will be further explained with reference to the drawings, wherein like numbers refer to like features and:

FIG. 1 is a cross section view of an illustrative embodiment of a linerless label pad of the invention;

FIG. 2 is a plan view of rear face of an illustrative label of the invention; and

FIG. 3 is a cross section view of another illustrative embodiment of a pad of the invention.

The figures are not to scale and intended to be illustrative only.

### DETAILED DESCRIPTION OF ILLUSTRATIVE EMBODIMENTS

For purposes of clarity and without intending to be unduly limited thereby, the labels in a group of any two sequentially stacked or successive labels are referred to herein as an overlying label and an underlying label. In the stack, the adhesive layer of the overlying label is releasably adhered to the front face of the underlying label.

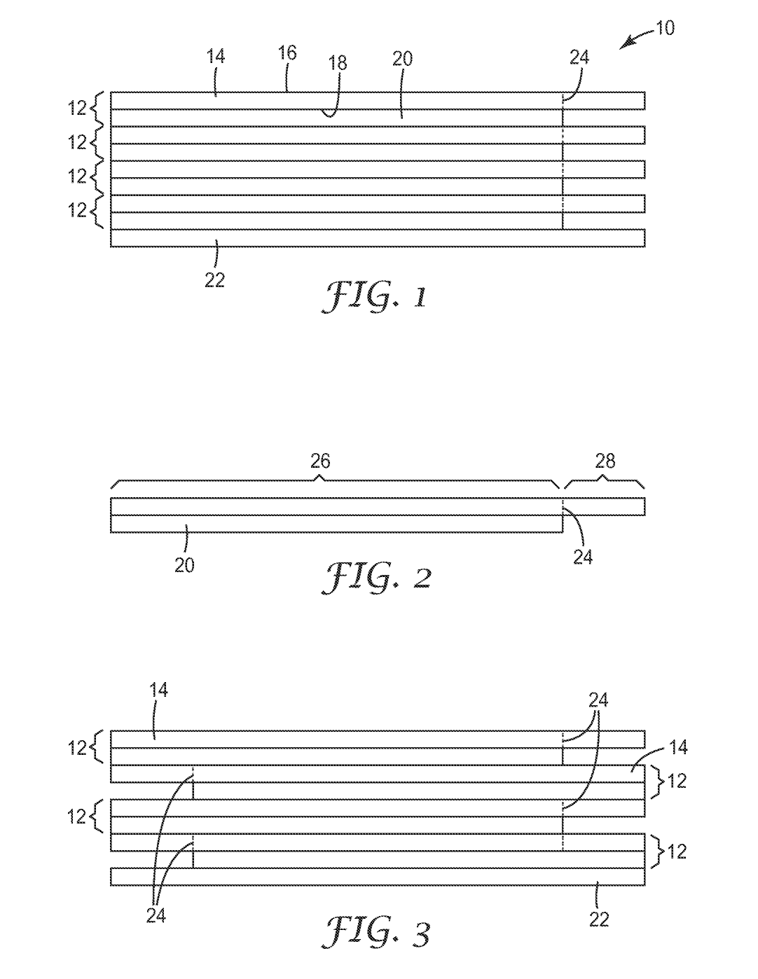

One embodiment of a stack or pad of the invention is shown in FIG. 1 wherein pad 10 comprises a stack of a plurality of labels 12, each label comprising a sheet 14 having front face 16 and back or rear face 18 and a layer of adhesive 20 on a portion but not all of the rear face 18 of the sheet 14. The labels are disposed in a stack with the adhesive of each label directly engaging the front face of the underlying sheet in the stack with no intervening liner. The adhesive of the bottommost sheet in the stack will typically engage an optional protective liner 22.

As is shown in FIG. 2, each sheet 12 has a weakened separation line 24 that divides its label portion 26 and tab portion 28. Typically it is preferred that the separation line is positioned substantially coextensive with the boundary of the portion of the sheet which is coated with the adhesive 20 and the portion of the sheet which is not coated with the adhesive. In order to ensure that entirety of the bottom surface of the label portion is coated with adhesive, e.g., to ensure good ultimate bond performance to the desired substrate article without undesirable edge lift, in some embodiments it may be preferable to position the weakened separation line just inside the portion of the sheet which is coated with adhesive, i.e., such that the adhesive fully covers the rear face of label portion 26 and extends beyond the line of separation slightly to also cover a limited portion of the rear face of tab portion 28 which is adjacent to label portion 26. In some embodiments, positioning the line of separation line at a position of up to about 2 mm, in other embodiments only up to about 1 mm, and in still other embodiments only up to about 0.5 mm, into the portion of the sheet that is coated with adhesive is suitable. If the weakened separation line is positioned too deeply into the adhesive coated portion, i.e., such that more significant portions of the tab portion are covered with adhesive performance may be undesirably impaired, e.g., there may be some tendency for the tab portions not to separate easily from underlying labels and/or subsequent removal of the tab portion from the article to which the label portion has been adhered. If the weakened separation line is positioned too far away from the adhesive coated area, leaving a portion of the label portion of the sheet without underlying adhesive, then the label may fail to adhere desirably to the substrate, may be subject to “edge picking” “edge lift”, etc. Those skilled in the art will be able to readily determine suitable location for the weakened separation line relative to the boundary of adhesive layer.

As will be understood by those skilled in the art, the weakened separation line may be formed by any known means, e.g., formation of a perforation line with a series of cuts and ties, slitting the sheet from the front surface and/or rear surface, etc. In many embodiments, the separation line is substantially straight but it may be curved if desired. Typically it is desired that the separation line is such that the sheet will tear to leave a substantially smooth edge, e.g., by use of fine ties if a perforation line is used, use of a sufficiently deep slit if the separation line is a slit. While the weakened separation line should not be so weak that the label cannot be removed from the stack as desired by lifting and grasping the tab portion and applying a separation force without premature separation of the tab portion from the label portion, it should also permit convenient separation as desired, e.g., by folding over and tearing, of the tab portion from the label portion after removal from the stack, commonly after adhesion to an article as desired. In the case of repositionable labels, the tab portion may by used to facilitate lifting and repositioning the label portion on the surface of the article after it has been initially tacked thereto before being positioned as finally desired. In such instances, the weakened separation line is preferably sufficiently strong to withstand such handling and manipulation prior to finally separating and tab portion removal when desired.

The tab portion is located at portion of the perimeter of the sheet. The tab portion may be of desired size and shape, with the choice being dependent, in part, upon the method by which a label of the invention will be removed from the stack, manipulated, then applied to a substrate. If the labels are intended to be dispensed from the stack and applied by hand, the tab portion should be configured of suitable size, shape, and location so as to be grippable by hand. If automated label application equipment is to be used, the tab portion should be configured accordingly.

Selection of the material to be used as sheets of labels of the invention will typically be made dependent in part upon the environment or application for which the labels are intended to be used, adhesive to be used, etc. Illustrative examples of suitable materials include paper, plastic films, metallic laminates, etc.

Depending upon the embodiment the front face of the label portion is indicia-receptive or writeable, is already printed with desired indicia (e.g., designs, symbols, alphanumeric characters, colors, or combinations thereof), or is both. In typical embodiments, the front surface is receptive to marking with common writing instruments such as pencils, ink pens and markers, e.g., ball-point, felt tip, etc., crayons, and the like. Depending upon the application for which the labels are to be used, it may be desired that the front face of the label portion be receptive to only selected materials so as to provide desired selective marking of labels of the invention. In indicia-receptive embodiments the invention, indicia may be applied to the front face of the label by suitable means to the label, e.g., when the label is the uppermost label in the stack, after the label has been removed from the stack, or after the label has been adhered to desired location on the substrate to which it is applied.

The adhesive will typically be a pressure sensitive adhesive selected dependent in part upon the application for which the label is intended, e.g., capable of achieving and sustaining desired adhesion under conditions of application and use of the article to which the label is applied, manner in which the label is to be applied, e.g., by machine or by hand, characteristics of the sheet, etc. In some applications it will be preferred that the adhesive is repositionable or removable, i.e., the adhesive is one which has the ability to be removed from a substrate after being adhered to such substrate without substantially damaging the substrate surface or leaving substantial adhesive residue thereon. Such adhesives have been known for a variety of product including, for example, such items POST-IT™ notes from 3M Company of Saint Paul, Minn.

If desired, the front face of the label may be treated to impart desired adhesion and release properties to the adhesive layer of the overlying label. An illustrative example includes a silicone release coat. Suitable selection of a release material may be readily made by one with ordinary skill in the art dependent in part upon the characteristics of the sheet and the adhesive composition being used.

If desired, the rear face of the label or at least the label portion thereof may be treated to impart desired performance to the adhesive layer of that label. Suitable selection of a treatment or coating, e.g., sometimes referred to as a tie layer, may be readily made by one with ordinary skill in the art dependent in part upon the characteristics of the sheet and the adhesive composition being used. As will be understood by those skilled in the art, the need for and selection of such treatments will be dependent in part upon the sheet and adhesive materials selected, strength of the weakened separation line, applications for which the labels are intended to be used, and methods intended to be used to apply the labels.

Stacks or pads of labels the invention will typically comprise a plurality of labels of the invention, stacked as described herein, numbering, for instance, from just a few labels to dozens or more of labels.

Another embodiment of a pad of the invention is shown in FIG. 3 wherein the labels are arranged in alternating orientation such that the tabs of successive labels in the stack are positioned on alternating sides of the stack.

An illustrative embodiment is a label comprising a rectangular sheet that is approximately 7.5 cm by 8.5 cm with a rectangular tab portion that is approximately 1 cm by 7.5 cm and a label portion that is approximately 7.5 cm by 7.5 cm square. As will be readily understood by those skilled in the art, labels may be made in any desired size and shape in accordance with the invention, e.g., rectangles, parallelograms, ovals, circles, complex shapes, etc.

According to the method of the invention, the uppermost label is removed from the stack by applying a separation force to its tab portion, e.g., by grasping the tab portion by hand and pulling, thereby causing the adhesive on the overlying label to separate from the front face of the underlying label. After removal from the stack the label, formerly referred to as the overlying label and now referred to as the dispensed label is placed in desired position on a substrate and adhered with the adhesive (and possibly initially tacked in place with the adhesive and lifted by the tab and repositioned one or more times in certain embodiments). The tab portion of the label is separated from the label portion, e.g., by folding along the weakened separation line and applying pressure to separate the tab portion and label portion. Typically the tab portion is removed after the label portion has been adhered to the article so that it can be used to facilitate handling of the label after removal from the stack. However, in some embodiments, it may be desired to separate the tab portion and label portion before adhering the label portion to an article.

The referenced descriptions contained in the patents, patent documents, and publications cited herein are incorporated by reference in their entirety as if each were individually incorporated.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A stack of labels comprising a plurality of labels, each label comprising a sheet having a front face and rear face opposite to the front face and a layer of pressure sensitive adhesive on a portion of the rear face of the sheet, each label having a separable tab portion and label portion, wherein the tab portion is substantially free of adhesive to facilitate grasping and removing the sheet from the stack, and the labels are arranged in a stack with no removable liner between successive labels, the adhesive on the rear surface of each label in the stack, with the exception of the lowermost label in the stack, overlying and being detachably adhered to the front surface of an underlying sheet.

2. The stack of claim 1 wherein the rear face of the label portion of each sheet is substantially completely covered with the adhesive.

3. The stack of claim 1 wherein the tab portion and label portion of each sheet are attached by a weakened separation line.

4. The stack of claim 3 wherein the strength of the weakened separation line is sufficient to permit the uppermost label to be grasped by the tab and pulled from the stack detaching the adhesive on the uppermost label from the underlying label.

5. The stack of claim 1 wherein the labels are arranged in alternating orientation such that the tab portion of each label is alternatively disposed with regard to the tab portion of the underlying label in the stack.

6. The stack of claim 1 wherein labels in the stack have a uniform shape.

7. The stack of claim 1 wherein said adhesive is a repositionable adhesive.

8. The stack of claim 1 further comprising a release coat covering the portion of the front face of each sheet which is in contact with the adhesive of the overlying sheet in the stack.

9. The stack of claim 1 wherein the front surface of the label portion is indicia-receptive.

10. The stack of claim 1 wherein the front surface of the label portion has indicia displayed thereon.

11. A method for labeling an article comprising:
providing a stack of claim 1;
providing an article; and
applying a separation force to the tab portion of the uppermost label in the stack, thereby causing the adhesive on the uppermost label to separate from the front face of the underlying label thereby yielding a dispensed label; and then
positioning the dispensed label in desired position on the article;
adhering the dispensed label to the article with the adhesive; and
separating the tab portion from the label portion of the dispensed label.

12. The method of claim 11 wherein applying a separation force comprises grasping said tab portion by hand and pulling such that the bond between the adhesive on the uppermost label and the front face of the underlying label is overcome and the uppermost label separates from the stack.

13. The method of claim 11 wherein adhering the dispensed label comprises applying pressure to the front face of the label portion of the dispensed label.

14. The method of claim 11 wherein the tab portion and label portion of the dispensed label are attached by a weakened separation line and the separating the tab portion from the label portion comprises folding the label along the separation line and applying pressure to cause the tab portion and label portion to separate.

15. The method of claim 11 wherein the front surface of the label portion is indicia-receptive and further comprising applying indicia to the front surface of the label portion of the label.
